(19) United States
(12) Patent Application Publication
(10) Pub. No.: US 2026/0218068 A1
(43) Pub. Date: Jul. 30, 2026

(54) PLASTIC TREATMENT PROCESS

(71) Applicant: BOREALIS AG, Vienna (AT)

(72) Inventors: Alberto MARTINEZ JOARISTI, Linz (AT); Ana Lilia MOTA SALINAS, Linz (AT); Tuomas OUNI, Espoo (FI); Rebeca REGUILLO CARMONA, Linz (AT); Nikolaos VAVIZOS, Schwechat (AT); Elisa VASKIKARI, Porvoo (FI); Kristofer DINGWELL, Stenungsund (SE); Tom HUIZINGA, TH IJsselstein (NL); Tommaso LUCIANI, Linz (AT)

(21) Appl. No.: 19/141,417

(22) PCT Filed: Dec. 22, 2023
(86) PCT No.: PCT/EP2023/087754

§ 371 Date: Jun. 20, 2025

(30) Foreign Application Priority Data
Dec. 23, 2022 (EP) 22216521.9

(51) Int. Cl. C10G 69/00; B01J 6/00; B01J 8/22; B01J 8/24; C10G 1/02

(52) U.S. Cl. CPC C10G 69/00; B01J 6/008; B01J 8/22; B01J 8/24; C10G 1/02; C10G 2300/1003

(57) ABSTRACT

The invention provides a process for the treatment of mixed plastic waste, said process comprising the following steps, in sequential order: a) converting a mixed plastic waste to a pyoil in a pyrolysis reactor; b) contacting at least a portion of the pyoil with a catalyst in the presence of hydrogen in a hydrotreatment unit to produce a hydrotreated pyoil; c) separating the hydrotreated pyoil into at least two fractions, wherein one of said fractions is a heavy fraction, preferably at least three fractions: a light fraction, a medium fraction and a heavy fraction, in a separating unit; and d) feeding the heavy fraction to a catalytic cracking reactor to produce a cracked heavy fraction.

This invention relates to the treatment of mixed plastic waste. In particular, the invention relates to a process and apparatus for the treatment of mixed plastic waste that involves pyrolysis of the plastic waste, hydrotreatment of the pyoil produced and separation of the hydrotreated product into at least two fractions, wherein the heavy fraction is fed to a catalytic cracking reactor.

### BACKGROUND

As concerns over the environment continue to grow, the recycling of plastic waste is now an important consideration for all plastic producers. The chemical recycling of plastic typically requires depolymerisation, generally but not exclusively by pyrolysis of mixed plastic waste (MPW) to produce pyrolyis oil (called pyoil herein).

Generally, the raw pyoil is not fed directly to steam crackers to produce monomers suitable for the production of plastics as crackers utilise saturated hydrocarbons as feedstock and a pyoil will contain many unsaturated or aromatic components. The pyoil is therefore typically pre-treated due to the high concentration of unsaturated components and impurities therein. This further treatment typically occurs in a hydrotreatment unit (HDT) followed by separation of the components that are formed based on their boiling points, i.e. fractionation.

The configuration of a system that can convert an MPW to the target hydrocarbon fractions can vary greatly, mainly depending on the quality of the MPW that is used. The MPW can vary based on the polyolefin content therein, its oxygen content, contaminant content and so on. Also, some MPWs can be used to target specific end products such as LPG-Naphtha to “heavies”.

The pyrolysis of the MPW is typically carried out at low pressure and high temperature, as this increases the yield of lower boiling points components, which are typically removed before hydrotreatment. Pyoil is the product from the pyrolysis reactor and is mostly condensed into the liquid state. As such, pyoil is a mixture of many components with a boiling range between 0 and 600° C., especially 50 and 500° C.

The hydrotreatment reaction needed to saturate components of the pyoil and remove contaminants typically requires pressures above 20 bar and temperatures in the range of 350-450° C., to increase the activity of hydrogen.

Chemical recycling processes using pyoil typically cool and depressurise the pyoil before it is sent to the hydrotreatment unit, either because it is desired to separate lights before the hydrotreatment unit or because of the pressure difference between the pyrolysis reaction and the pressure required for the hydrotreatment unit is high. It is challenging to increase the pressure of the pyoil from the pyrolysis reactor to the hydrotreatment unit when the pyoil is partially in gaseous form. The pyoil is therefore cooled, gaseous lights can be removed and the pressure and temperature increased in the liquid state to the operating pressure and temperature of the hydrotreatment unit.

As a result, pumps to increase the pressure of the liquid pyoil, heat exchangers and a furnace need to be installed to heat up the pyoil up for the hydrotreatment unit.

Various MPW treatment processes are known. WO 2018/055555 describes a process for the production of hydrocarbons from plastic waste. The plastic waste is converted to a gas stream and liquid stream in a pyrolysis unit and subsequent separating unit. The liquid stream is then transferred to a hydroprocessing unit, after which it is separated into a heavies stream and treated hydrocarbon stream.

The heavies stream is passed to a hydroalkylating unit and the treated hydrocarbon stream is subjected to steam cracking and separation to yield at least four hydrocarbon streams.

WO 2018/127813 describes a process for producing propylene and cumene. A plastic waste is converted to a hydrocarbon liquid stream and a pyrolysis gas stream in a pyrolysis unit. The hydrocarbon liquid stream is subjected to hydroprocessing in the presence of hydrogen in a hydroprocessing unit to yield a C5+ hydrocarbon product and a first gas stream. That hydrocarbon product is subject to a second separation to produce a C6 aromatics stream and C5+ hydrocarbons stream. A portion of saturated hydrocarbons isolated in the second separation is recycled to the pyrolysis unit or the HDT.

WO 2018/069794 describes a process for producing olefins and aromatic hydrocarbons from mixed plastics. The mixed plastics are converted in a pyrolysis unit to a hydrocarbon product comprising a gas phase and a liquid phase. These streams are separated and the liquid stream is further separated into a first lower boiling point fraction and a second higher boiling point fraction. The second fraction is recycled to the pyrolysis unit and the first fraction is sent to a liquid steam cracker optionally via an hydrotreatment unit. In a further embodiment, after the mixed plastics are converted in a pyrolysis unit to a hydrocarbon product comprising a gas phase and a liquid phase, the liquid phase is hydrotreated and the resulting hydrotreated pyoil is separated into a light and heavy fraction. The heavy fraction can be recirculated to the pyrolysis unit. There is no recirculation therefore direct from the hydrotreatment unit to pyrolysis reactor.

WO 2015/128033 relates to a process for converting MPW into valuable petrochemicals, comprising feeding MPW to a pyrolysis reactor, converting the MPW into a gaseous stream and a liquid stream. The gaseous stream is further processed into valuable petrochemicals. The liquid product from the pyrolysis reactor is fed to a separator to extract aromatics, and the rest is fed to a hydrocracking unit. The gas product from the hydrocracker is further processed in a similar way as the gas product from the pyrolysis. The liquid product from the hydrocracker is as well converted into valuable petrochemicals.

WO 2021/204818 describes a process for producing olefins from a hydrocarbon stream, comprising converting pyrolysis plastic oil into high value chemicals via catalytic cracking of the pyrolysis plastic oil. The technical problem which this invention seeks to solve is to improve the purification of pyrolysis plastic oil before undergoing steam cracking, to prevent the use of high quantities of hydrogen and to avoid high operational costs.

US 2019/299491 is directed to a process for processing mixed plastics comprising simultaneous pyrolysis and dechlorination. The technical problem which this invention seeks to solve is the production of feedstock for steam crackers which are free of chlorine and are thus suitable to meet steam cracker feed requirements.

WO 2016/142809 describes an integrated process for the conversion of waste plastics to high value products. The MPW is fed to a pyrolysis unit, and then to an HDT unit. The process allows for operation with a single hydroprocessing reactor which provides simultaneous hydrogenation, dechlorination, and hydrocracking of components of a hydrocarbon stream to specifications which meet steam cracker requirements, with the option to further dechlorinate the treated hydrocarbon stream in a polishing zone.

After the mixed plastic waste is pyrolysed it is normal to separate the pyoil to recover at least the lights (low boiling point) fraction. For that reason, pyrolysis is typically effected at low pressures to facilitate the extraction of lights from the pyrolysis reactor. If the pressure in the pyrolysis reactor was high then these lights are more likely to be in the form of a liquid.

Typically, therefore the lights are separated to leave a liquid hydrocarbon stream that needs hydrotreatment, i.e. hydrogenation to create saturates that can be cracked. The lights are removed and the resulting liquid hydrocarbon stream is then reheated and the pressure increased for entry into the hydrotreatment unit.

Within the hydrotreatment unit, recycles are needed in order to control the exothermicity from the hydrogenation reactions. On exit from the hydrotreatment unit, the heavies stream is typically separated off and often subjected to further cracking either by recirculation to the pyrolysis unit or via hydrocracking.

Pyoil from the pyrolysis reactor cannot be fed to directly to the cracker due to level of impurities and level of unsaturation present in the pyoil. Impurities damage the catalyst and unsaturated compounds may polymerise at high temperatures before reaching the furnace in the steam cracker.

The process of the invention is particularly suited for handling chlorinated impurities in the pyoil. Whilst it is ideal to separate chlorinated containing plastics (such as PVC) before pyrolysis, any that pass through such a separation process can be pretreated before the pyrolysis reaction, e.g. at lower temperatures (ca. 300° C.), to convert chlorine in the mixed waste into hydrogen chloride The non-chlorinated waste melts at this temperature and can enter the pyrolysis reactor.

### SUMMARY OF INVENTION

The present invention relates to a process wherein, on exit from the hydrotreatment unit, the treated pyoil stream is separated into at least two fractions, wherein the heavies fraction is fed to a catalytic cracking unit. This offers the advantage that the process is less demanding in H₂ and allows an energy efficient cracking of molecules at the cost of transforming some of the pyrolysis oil into coke in the catalyst, which needs to be regenerated creating CO₂ emissions. These CO₂ emissions can be minimized by using Carbon Capture technologies.

Viewed from one aspect the invention provides a process for the treatment of mixed plastic waste, said process comprising the following steps, in sequential order:
a) converting a mixed plastic waste to a pyoil in a pyrolysis reactor;
b) contacting at least a portion of the pyoil with a catalyst in the presence of hydrogen in a hydrotreatment unit to produce a hydrotreated pyoil;
c) separating the hydrotreated pyoil into at least two fractions, wherein one of said fractions is a heavy fraction, preferably at least three fractions: a light fraction, a medium fraction and a heavy fraction, in a separating unit; and
d) feeding the heavy fraction to a catalytic cracking reactor to produce a cracked heavy fraction.

Viewed from another aspect the invention provides a system arranged to perform a process as herinbefore defined, wherein said apparatus comprises:
(i) A pyrolysis reactor configured to receive a mixed plastic waste stream and to produce a pyoil;
(ii) A hydrotreatment unit configured to receive hydrogen and the pyoil and to produce a hydrotreated pyoil;
(iii) A separation unit configured to receive the hydrotreated pyoil and to produce three fractions: a light fraction, medium fraction and heavy fraction; and
(iv) A catalytic cracking reactor configured to receive the heavy fraction and to produce a cracked heavy fraction.

### Definitions

Mixed plastic waste is abbreviated MPW herein. By MPW is to be understood waste, which is made entirely or primarily of plastic materials i.e. the level of non-plastic material in the waste should preferably be no more than 10 wt %.

The pyrolysis reactor is a vessel in which the MPW and optional recycled hydrotreated pyoil is heated under pressure to generate a pyrolysis oil. There should not be any hydrogen feed to the pyrolysis reactor. The terms pyrolysis reactor and pyrolysis unit are used interchangeably herein.

The product formed in the pyrolysis reactor is a pyrolysis oil, called pyoil herein.

The hydrotreatment unit is a vessel, or more than one vessel connection in series, in which a hydrogenation reaction occurs to saturate unsaturated components of the pyoil.

It will be appreciated that conveying conduits (typically pipes) including direct conveying conduits from one unit to another within the apparatus of the invention may require pumps (if gravity cannot be used) and that any conduit that enables transfer may contain valves to prevent back flow. These are not discussed further herein.

The term “heavies” or “heavy fraction” defines a liquid hydrocarbon with an API gravity less than 20°. The heavy fraction typically comprises hydrocarbon compounds with a boiling point above 360° C., usually with a carbon atom number above C20-C24.

The term “lights” or “light fraction” means a hydrocarbon fraction typically having a boiling point below 200° C., usually with a carbon atom number of C4-C12.

The term “medium” or “medium fraction” means a hydrocarbon fraction typically having a boiling point between 200 and 360° C., usually with a carbon number of C10-C24.

The terms recycle or recirculate are used interchangeably herein.

### DETAILED DESCRIPTION OF INVENTION

This invention relates to a process and apparatus for recycling mixed plastic waste. The mixed plastic waste can be derived from post-industrial or post-consumer plastic waste. Mixed plastic wastes can comprise chlorinated plastics, such as chlorinated polyethylene, polyvinylchloride (PVC) or polyvinylidene chloride (PVDC), or non-chlorinated plastics, such as polyolefins, such as polyethylene, polypropylene, polyethylene terephthalate (PET), polybutylene terephthalate, and polystyrene.

In some aspects, the mixed plastics can comprise PVC, PVDC, polyethylene terephthalate, polybutylene terephthalate, polyolefins, polystyrenes and the like, or combinations thereof. Waste plastics as disclosed herein also include used tires.

It is preferred if the mixed plastic waste is primarily polyolefinic. It is preferred if the mixed plastic waste comprises more than 75 wt % polyolefinic components, especially at least 75 wt % polyethylene and polypropylene components.

Ideally, the mixed plastic waste used herein should contain 10 wt % or less of chlorinated plastics. In one embodiment therefore, the invention may utilise a sorting unit to separate out any plastics that are unsuitable for pyrolysis, e.g. chlorinated plastics.

It is appreciated, however, that even a MPW that is nominally free of chlorinated plastics might contain contaminants. It is therefore preferred if any MPW is subject to a dechlorination process before entering the pyrolysis unit. This step is designed to remove chlorine (e.g. in the form of HCl) and other heteroatoms from the hydrocarbons that are present in the MPW.

Dechlorination of plastic mixtures from domestic waste as well as from other chlorine containing mixtures such as electronic scrap is an important step in chemical recycling of polymers. To ensure that the pyrolysis procedure is safe, the nature of any combustion processes and the emissions from the pyrolysis unit etc. must be known. Removing chlorine (and other heteroatoms) is preferred before a pyrolysis process occurs therefore as chlorine waste gases (and other heteroatom containing gases) are avoided.

Dechlorination of the MPW can be carried out in a dechlorination reactor which is a vessel adapted to allow moderate heating of the MPW and to allow chlorinated gases (and other heteroatom gases) that are formed to be removed. It is preferred if the dechlorination reactor is effected in the absence of hydrogen.

It may be that along with heteroatom containing impurities, some light gaseous hydrocarbons are formed during the dechlorination step. These can be removed with the heteroatom containing impurities and the gaseous products sent to a scrubber. Light hydrocarbons of value can then be separated and recovered from the scrubber using known processes.

The dechlorination of chlorinated plastics can be conducted at moderate temperatures prior to the thermal degradation of the polymer. Low temperature heating of the MPW can convert chlorine in the MPW into hydrogen chloride.

Suitable temperatures are 150 to 350° C., preferably 250 to 300° C. Often the dechlorination step will be effected at lower temperature than the pyrolysis step, such as <250° C. The temperature should be sufficient to decompose PVC producing HCl gas, without actually pyrolysing the MPW.

Suitable pressures are 1 to 5 bars. This process can be comparatively short compared to the actual pyrolysis process. Typical hourly space velocity of the fresh melt fed from about 0.2 h⁻¹ to about 0.5h⁻¹, and it can be under a nitrogen blanket or a dedicated nitrogen sweeping rate.

The dechlorination process (which is known in the art) can ensure that the chloride levels in the MPW fed to the pyrolysis reactor are less than about 10 parts per million weight (ppmw) chloride, alternatively less than about 5 ppmw chloride, or alternatively less than about 3 ppmw chloride, based on the total weight of the MPW.

After the MPW has been optionally dechlorinated, the MPW is passed to the pyrolysis reactor.

The feed to the pyrolysis unit comprises the MPW optionally sorted and dechlorinated as discussed above and the optional cracked heavy fraction from the hydrotreatment unit described further below. It is also possible that a pyoil from another source or a biooil may be fed to the pyrolysis reactor as an additional feed.

It is preferred if MPW forms at least 75 wt % of the feed to the pyrolysis reactor.

### Pyrolysis

The pyrolysis reactor may be any suitable vessel configured to convert mixed waste plastic into gas phase and liquid phase products (e.g. simultaneously). The pyrolysis reactor may contain inert material (such as sand, alumina) or a pyrolysis catalyst, e.g. zeolite. It is however preferred if no catalyst is used and the process simply involves heat. The pyrolysis unit may be operated adiabatically, isothermally, nonadiabatically, non-isothermally, or combinations thereof.

The pyrolysis reaction is ideally carried out in a single pyrolysis reactor although in theory two pyrolysis reactors connected in series might be used. In that scenario the optional recycle stream of the cracked heavy fraction should occur to at least one, preferably both reactors. If the optional recycle occurs to one unit then it is preferably the first in the sequence.

One such reactor might use a catalyst (and hence generate a catalytically cracked pyoil) and one might use simply thermal treatment to generate a thermally cracked pyoil. Catalysts of interest in the process are known and any conventionally known catalyst can be used. Typical catalysts include zeolites.

The pyrolysis unit can be configured to pyrolyse (e.g. crack) components of the mixed plastics stream fed to the pyrolysis unit. Examples of reactions which may occur in the pyrolysis unit include isomerisation, selective ring opening, cracking of long chain molecules or combinations thereof.

The pyrolysis reactor processes may occur at a temperature of 250° C. to 700° C., alternatively 275° C. to 600° C., or alternatively 300° C. to 400° C. More preferably however the temperature is at least 400° C. such as 400 to 700° C.

The pyrolysis reaction is performed at a range of 1.0 to 100 bar, preferably in the range of 1 to 10 bar, especially 1 to 5 bar.

The residence time within the pyrolysis reactor may be 10 to 180 min depending on temperature, preferably 15 to 60 min.

Typically, the pyrolysis process occurs at a higher temperature and for longer than any dechlorination process.

The pyrolysis reactor is preferably operated continuously and hence pyoil that forms is constantly removed from the pyrolysis reactor during operation.

Typically, the pyoil that forms is separated into gas and liquid portions after the pyrolysis reactor. The pyoil is therefore fed to a separating unit that acts as a condenser. The gas stream may be removed and the liquid hydrocarbon stream that is formed may then be conveyed to the hydrotreatment unit. The liquid hydrocarbon stream is then reheated and pressurised up to the required conditions in the hydrotreatment unit.

In a preferred embodiment, the pyrolysis reactor does not act as a hydrotreatment unit. It is thus preferred that no hydrogen is fed into the pyrolysis reactor. It is therefore preferred if there is a separate hydrotreatment unit.

The benefits of having a separate hydrotreatment unit are numerous.

Hydrogenation is performed at high pressures (and high temperatures) to increase activity as hydrogen is a gas. In the pyrolysis reactor, low pressure is preferred as this allows the light fraction to evaporate and leave the pyrolysis reactor without consuming further energy. Lower pressure also reduces the risk of cracking to less valuable products (like CH₄), or reactions with other components of the pyoil.

A catalyst is required in the hydrotreatment unit. This hydrogenation catalyst is typically a metal catalyst on a support. Active hydrogenation metals are very sensitive to poisons, and they would quickly deactivate in a pyrolysis reactor as all impurities are still present. As most impurities remain in the ash they will not reach the hydrogenation reactor, and the catalyst is therefore more protected against poisoning.

Having a separate hydrotreatment unit also allows an optimum configuration to be adopted. The hydrotreatment unit may contain 3 phases (hydrogen gas, pyoil liquid, and the catalyst solid), which require a very special configuration to have proper flow distribution, mass and heat transfer. This is not possible in a pyrolysis reactor, with very viscous fractions and ash being formed, which would disturb the flow pattern.

Moreover, a dedicated hydrotreatment unit allows the use of different residence times than might be used in the pyrolysis reactor.

It may be that a filter is used to filter the pyoil before it enters the hydrotreatment unit. The filter simply removes any solid components that may be present in the pyoil.

In light of the different conditions, particularly in terms of temperature and pressure, in the pyrolysis reactor and the hydrotreatment unit, the pyoil is usually cooled on exit from the pyrolysis reactor to a temperature below 100° C., such as 0-100° C., preferably 0-50° C. Subsequently, temperature and pressure of the pyoil is then increased to above 10 bar and a temperature higher than 150° C., ideally to match the conditions of the hydrotreatment unit, as discussed herein below.

### Hydrotreatment Unit

In the hydrotreatment unit, hydrogen is fed to saturate the compounds present and hence to form a hydrotreated pyoil. Preferably, therefore the only feed to the hydrotreatment unit is pyoil and hydrogen, and optionally any recycled cracked heavy fraction. A hydrotreatment unit may be any vessel configured to contain the hydrotreating reaction. It may be one reactor or comprise two or more reactors connected in series. In that scenario the optional recycle stream of the cracked heavy fraction should preferably occur to one reactor, ideally the first in the sequence.

A hydrotreatment reactor may include one or more beds of a hydrotreatment catalyst. A hydrotreatment reactor may be operated adiabatically, isothermally, nonadiabatically, non-isothermally, or combinations thereof.

The hydrotreatment reactor is preferably operated using a catalyst in the presence of hydrogen. Unsaturated compounds are therefore converted to saturated ones e.g., olefins, aromatic compounds to paraffins, i-paraffins, naphthenes.

Additionally, reactions in a hydrotreatment reactor may cause a rupture of a bond of an organic compound, resulting in “cracking” of a hydrocarbon molecule into two or more smaller hydrocarbon molecules.

The hydrotreatment catalyst may be any catalyst used for hydrogenation of olefins and aromatic hydrocarbons (e.g. a commercially available hydrotreating catalyst). The hydrotreatment catalyst can comprise a cobalt and molybdenum catalyst (Co—Mo catalyst) e.g. on an alumina support, a nickel and molybdenum catalyst (Ni—Mo catalyst) e.g. on an alumina support, a tungsten and molybdenum catalyst (W—Mo catalyst) e.g. on an alumina support, cobalt and molybdenum oxides e.g. on an alumina support, nickel and molybdenum oxides e.g. on an alumina support, tungsten and molybdenum oxides e.g. on an alumina support, cobalt and molybdenum sulphides e.g. on an alumina support, nickel and molybdenum sulphides e.g. on an alumina support, tungsten and molybdenum sulphides e.g. on an alumina support, a zeolite comprising one or more metals or combinations thereof.

Other catalysts suitable for use as the hydrotreatment catalyst may include platinum and palladium catalyst (Pt—Pd catalyst) e.g. on an alumina support, nickel sulphides suitable for slurry processing, molybdenum sulphides suitable for slurry processing, and the like, or combinations thereof. The zeolites can comprise ZSM-5, ZSM-11, Y, high-silica Y, USY, and the like, or combinations thereof. Each metal of the one or more metals of the zeolite can be independently selected from the group consisting of cobalt, molybdenum, tungsten, nickel, titanium, copper, magnesium, tin, iron, zinc, tungsten, vanadium, gallium, calcium, manganese, ruthenium and rhenium.

The hydrotreatment unit is preferably operated at a temperature of 150 to 700° C., such as 300 to 550° C., preferably 350 to 500° C., especially 400 to 450° C.

There are no preferably no internal recirculations within the hydrotreatment unit.

The hydrotreatment unit can operate at pressures of 1.0 to 100 bar, such as

20 to 50 bar.

The residence time within the hydrotreatment unit is 0.2 to 10 hours, preferably 5 to 10 hours.

In an especially preferred embodiment, the hydrotreatment in the hydrotreatment unit occurs after the pyrolysis in the pyrolysis reactor. It is preferred if the hydrotreatment and pyrolysis steps are not conducted simultaneously. Hydrotreatment is important as the pyoil may contain a high number of dienes. These molecules are reactive and cannot be fed to the steam cracker as they might cause fouling, gums, blockages etc.

The hydrotreated pyoil is then separated into at least two fractions, wherein one of said fractions is a heavy fraction (the other being a lighter fraction). Preferably, the hydrotreated pyoil is separated into three fractions based on the boiling point of the fractions. These three fractions are termed the “light fraction”, “medium fraction” and “heavy fraction”.

There are important advantages to separating the pyoil into at least two fractions, preferably at least three fractions after hydrotreatment.

After hydrotreatment, a steam cracker is employed. Feeding a distillate with broad composition distribution to the steam cracker, results in very inefficient cracking, as only one temperature, and steam: hydrocarbon feed ratio can be chosen. Having a more defined feed allows much better utilization and performance of steam cracker asset. Typical distillation curves from pyoil start at 0-40° C.; and reach up to 600-700° C. (with a very heavy pyoil fraction). A feed comprising such a range of components is challenging and hence the separation process of the invention offers a distinct benefit.

As we crack only the heavy fraction, this can be subject to further pyrolyisation, and recycled. This can reduce the boiling point of the pyoil fraction.

Moreover, separating into components before hydrogenation causes technical concerns, as separations are carried out using thermal methods like distillation. To separate the light and medium fraction, the pyoil is heated up to ca. 400° C. But before hydrogenation, it is full of dienes and reactive molecules which can easily polymerized when heated at those temperatures. Performing the hydrogenation before the separation saturates the dienes and stabilizes the pyoil, allowing a much better performance of the distillation column.

The light fraction typically comprises hydrocarbon compounds with a boiling point below 200° C. The medium fraction typically comprises hydrocarbon compounds with a boiling point in the range 200 to 360° C. The heavy fraction typically comprises hydrocarbon compounds with a boiling point above 360° C.

Separation typically takes place in a fractional separator. The fractional separator may use packed beds, sieve trays, clock bottoms, packing material or other material that ensure good gas/liquid contact. The quality of the contact is important to get good separation of the components in the tower. In one embodiment, packed beds may be used.

In one embodiment, it is envisaged to collect three fractions from the fractional separator, a light fraction, a medium fraction, and a heavy fraction. In a still further embodiment, three final products are obtained from said fractional separation step being a light fraction, such as mainly C4 to C12; a medium fraction, such as mainly C10 to C24 and a heavy fraction, such as mainly C20 and above.

Typically, the light fraction is collected at the top of the column after being condensed. The medium fraction is collected between the bottom and the top of the column where the quality is according to specifications. The heavy fraction is collected at a low point of the column.

The reboiler is located at the bottom of the tower. The reboiler supplies the necessary heat to the fractional separator, in particular consumed for evaporation.

In one embodiment, the fractional separator operates at vacuum, but may also be designed to operate at any pressure, typically up to 50 bar.

In a further embodiment, the fractional separator is designed to operate at vacuum, with the feed pre-heated to approximately 160° C. in a pre-heater before entering the fractional separator. At this temperature, the feed will be approximately 50/50 wt % split of vapour and liquid. Due to the mixed feed stream after heating, a flash vessel is introduced before the fractional separator to ensure adequate liquid-vapour separation so that the vapour does not create turbulence and disturb the equilibrium of the fractional separator.

In a further embodiment, the diameter of the column may be 1000 mm and the height 15000 mm.

In one embodiment, the top operating pressure of the column can be 100 mbar to maintain bottom temperature at 290° C.

To provide some process flexibility to the fractional separator, the feed can be introduced to the fractional separator at different feed locations and also side draw locations can be adjusted. Such fractional separator will not be detailed further, as it is known to a person skilled in the art.

It is especially preferred if the hydrotreatment step occurs before the separation. Steps a) to c) are preferably sequential therefore.

In one embodiment, the pyoil is not subject to a separate step (other than the filtration of solid residue and removal of sour water) before hydrotreatment.

In the present invention therefore, on exit from the hydrotreatment unit, the treated pyoil stream is separated into at least two fractions, wherein at least the heavies fraction is fed to a catalytic cracking unit. It is also possible to fed one or more of the light and medium fractions to the catalytic cracker.

The process of the invention offers the advantage that the process is less demanding in H₂. This is a reflection of the hydrogen to carbon balance (H/C) as explained below.

### Catalytic Cracking

At least the heavy fraction of the hydrotreated pyoil is then fed to a catalytic cracking unit for further cracking. The components present in the hydrotreated pyoil are typically saturated at this point and can be readily cracked. In the catalytic cracker, saturated hydrocarbons are broken down into smaller, often unsaturated, hydrocarbons. It is the principal industrial method for producing the lighter alkenes, including ethylene and propylene.

The catalytic cracker may use steam, in the presence of a catalyst, in steam cracking furnaces to produce lighter hydrocarbons and is conventional. Any hydrogen that is emitted can be used in the hydrogenation reaction in the hydrotreatment unit.

In one embodiment, the temperature as measured in the catalytic cracking reactor is kept around 420° C., but the catalytic cracking reactor may also be operated at temperatures from between 350° C. to 550° C., and preferably between 380 and 460° C.

In one embodiment, the operating pressure is around 1 to 3 bar, such as 1 bar. In a further embodiment, the operating pressure is in a range between 0.1 and 10 bar, such as in the range from 0.5 to 5 bar, like in the range from 0.7 to 2 bar.

In a further embodiment, catalytic cracking is performed at an operating pressure of 2 bar and at temperatures between 350° C. and 650° C., and preferably between 450° C. and 550° C., such as around 500° C.

Multiple types of reactor may be used. In one embodiment, a packed-bed reactor is used. In another embodiment, a fixed-bed reactor is used, for example filled with a honeycomb structure. In a further embodiment, a fluidised-bed reactor is used. In another embodiment, a moving bed reactor is used. In another embodiment, a riser is used. Preferably, a riser is used.

Many catalysts are known to function well for catalytic cracking and can be used according to the invention for example ultrastable Y zeolite (USY) for catalytic cracking. Other catalytic cracking catalysts with good performances may also be used such as acid zeolite catalysts. Mixed metal sulphides or noble metal catalysts are also used.

In a preferred embodiment, the cracker is a fluid catalytic cracker. Advantageously, the catalytic cracker used in the invention may not need a hydrogen feed. This is a reflection of the hydrogen to carbon balance (H/C).

Polyethylene and polypropylene have an H/C of 2.0. Other plastics have a lower value.

Typical naphtha, a conventional feed to a cracker, has H/C of around 2.3, and the main products of the steam cracker, ethylene and propylene have a H/C of 2.0. As a result, steam crackers are net producers of hydrogen.

Pyoil has a lower H/C ratio, as part of the pyrolysis reaction results in hydrogen, methane and other very light components. The H/C of the pyoil is not homogeneous, and it is typically related to its boiling point. As boiling point is increasing, H/C is decreasing. A heavy fraction pyoil therefore has a low H/C ratio.

It is easiest for the steam cracker to utilise a feed with an H/C ratio similar to naphtha (i.e. rather high). Lower H/C components (higher boiling point, heavy pyoil) are therefore a more challenging feed for a steam cracker as a lot of coke is formed. The heavy fraction obtained in the present invention has a H/C ratio lower than 1.8.

Coke can be avoided using hydrocracking (500-700° C., 40-80 bar, adding excess of hydrogen to increase the H/C ratio, decrease the boiling point). This process therefore requires the use of hydrogen at high pressure and temperature which is expensive and energy consuming.

In one embodiment, the present inventors propose a solution in which the H/C ratio in a catalytic cracking process (e.g. 500-800° C., 1-3 bar) is transformed by allowing a fraction of the heavy pyoil to convert into coke (H/C~1.0) as the result is that the H/C ratio for the rest of feed increases. There is then no need to move hydrogen in recycles, separations or energy intensive operations. This coke portion can be removed from the fluid catalytic cracker, e.g. into a regenerator. The remaining material within the cracker has a higher H/C ratio and after cracking it can be split with the heavy portion recycled to the pyrolysis reactor and lights separated. This is illustrated in FIG. 2.

The cracked stream or a fraction thereof can be send to the purification unit after the steam cracker depending on the range of products, as it is already rich in olefins.

The formation of coke or other impurities on the catalyst surface will deactivate the catalyst. Because of this, regeneration of the catalyst is advantageously performed. In one embodiment, the reactor is typically equipped with an in-situ cleaning/regenerating system, as known in the art for example a system using air, water or inert gas mixture to regenerate the catalyst. In such an embodiment, the reactor may be coupled to a method for carbon capture, to capture the CO₂ generated during regeneration of the catalyst.

On exit from the catalytic cracking reactor, a portion of the cracked heavy stream may be recirculated to the pyrolysis reactor and/or the hydrotreatment unit.

In one embodiment, 50 to 100 wt %, such as 75 to 100 wt % of the cracked heavy stream can be recirculated back to the pyrolysis reactor and/or hydrotreatment unit. It can be envisaged that the recirculated cracked heavy stream may act as a kind of solvent in the pyrolysis unit.

The invention further relates to an apparatus suitable for carrying out the process of the invention. The apparatus will be further defined in relation to FIG. 1 below.

### BRIEF DESCRIPTION OF THE FIGURES

FIG. 1 shows an apparatus suitable for use in the treatment of mixed plastic waste according to the invention.

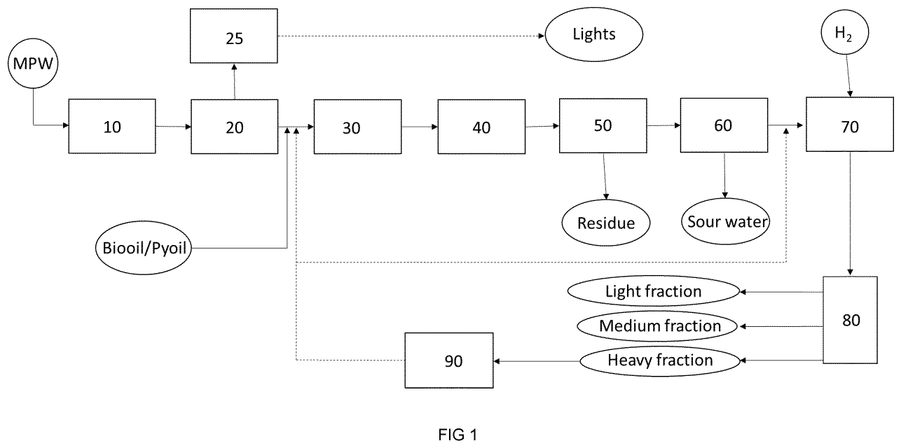

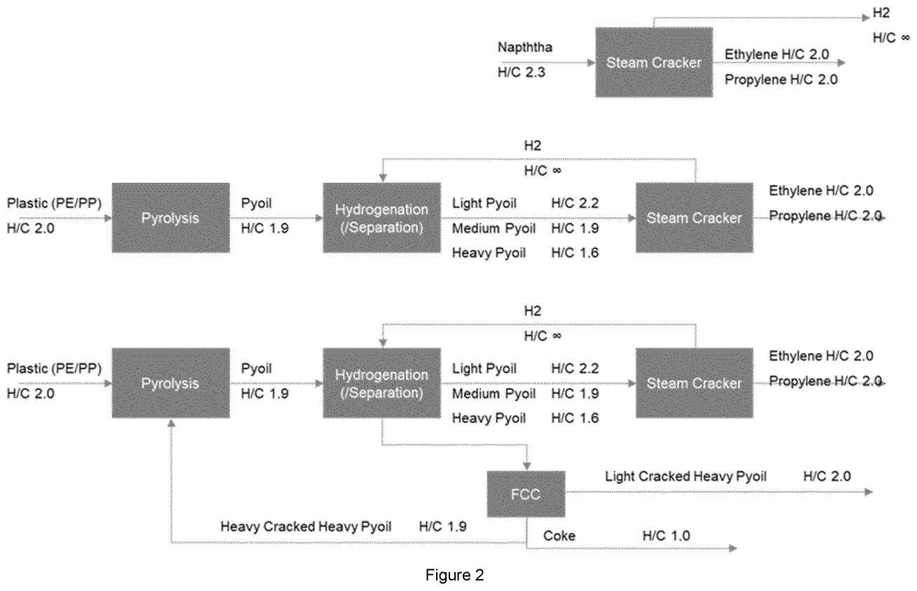

Mixed plastic waste can be fed to the pyrolysis unit 30 via a sorting unit 10 and a dechlorination unit 20. Any material removed during the dechlorination step can be sent for scrubbing in the scrubber 25 from where lights can be isolated.

Biooil or pyoil from another source can also be fed into the pyrolysis unit. There is also the option that a heavy fraction recovered downstream after the separation of the hydrotreated pyoil may be recycled to the pyrolysis unit.

The pyoil is then condensed in a condensation unit 40.

The pyoil can be filtered in a filter 50 to remove any solid components and the residue recovered. It can subsequently be passed through a desalter 60, forming sour water, which is separated off.

The pyoil then passes to a hydrotreatment unit 70. Hydrogen is fed to the hydrotreatment unit from a hydrogen store via a compressor.

The hydrotreated pyoil formed in the hydrotreatment unit can be transferred to a separation unit 80 where at least three fractions are formed: a light fraction, a medium fraction and a heavy fraction. The heavy fraction is directed to a catalytic cracker 90.

Optionally, there is a recycle stream from the catalytic cracker 90 to the pyrolysis reactor 30 and/or hydrotreatment unit 70.

The apparatus of the invention therefore contains as essential features:
a) A pyrolysis reactor configured to receive a mixed plastic waste stream and to produce a pyoil;
b) A hydrotreatment unit configured to receive hydrogen and the pyoil and to produce a hydrotreated pyoil;
c) A separation unit configured to receive the hydrotreated pyoil and to produce three fractions: a light fraction, medium fraction and heavy fraction; and
d) A catalytic cracking reactor configured to receive the heavy fraction and to produce a cracked heavy fraction.

FIG. 2 shows a process of the invention along with typical, non-limiting H/C ratios in various processes. The H/C ratios are provided purely therefore as a guide to some typical numbers.

In a first embodiment, after hydrogenation and separation the heavy fraction and optionally the light and medium fraction are sent to a steam cracker. Hydrogen generated is recycled to the hydrotreatment unit.

In option 2, some of the heavy fraction (or all of it) is sent to a fluid catalytic cracker where coke is formed. This can be removed to leave a remaining hydrocarbon mixture with a higher H/C ratio. A recycle to the pyrolysis reactor is possible.

1. A process for the treatment of mixed plastic waste, said process comprising the following steps, in sequential order:
a) converting a mixed plastic waste to a pyoil in a pyrolysis reactor;
b) contacting at least a portion of the pyoil with a catalyst in the presence of hydrogen in a hydrotreatment unit to produce a hydrotreated pyoil;
c) separating the hydrotreated pyoil into at least two fractions whereof one heavy fraction, preferably at least three fractions: a light fraction, a medium fraction and a heavy fraction, in a separating unit; and
d) feeding at least the heavy fraction to a catalytic cracking reactor to produce a cracked heavy fraction.

2. The process as claimed in claim 1, further comprising step e) recirculating at least a portion of the cracked heavy fraction to the pyrolysis reactor in step a) and/or the hydrotreatment unit in step b).

3. The process as claimed in claim 1, further comprising the steps:
a₁) decreasing the temperature of the pyoil below 100° C.; and
a₂) increasing the temperature and pressure of the pyoil above 10 bar and a temperature higher than 150° C.;
wherein steps a₁) and a₂) take place in sequential order between steps a) and b).

4. The process as claimed in claim 1 wherein the mixed plastic waste is subject to one or more pre-treatment steps prior to step a).

5. The process as claimed in claim 4, wherein said one or more pre-treatment steps comprises a dechlorination step.

6. The process as claimed in claim 1, wherein the heavy fraction comprises hydrocarbon compounds with a boiling point above 360° C..

7. The process as claimed in claim 1, wherein the cracked heavy fraction is not fed through a further separating unit after step d).

8. The process as claimed in claim 1, wherein the pyoil is passed through a filter and/or desalter between steps a) and b).

9. The process as claimed in claim 1, wherein the light fraction comprises hydrocarbon compounds with a boiling point below 200° C..

10. The process as claimed in claim 1, wherein the medium fraction comprises hydrocarbon compounds with a boiling point in the range 200 to 360° C.

11. The process as claimed in claim 1, wherein step a) takes place at a temperature of 250 to 700° C. and a pressure of 1.0 to 100 bar.

12. The process as claimed in claim 1, wherein step b) takes place at a temperature of 150 to 600° C. and a pressure of 1.0 to 100 bar.

13. The process as claimed in claim 1, wherein 50 to 100 wt % of the cracked heavy fraction is recirculated to the pyrolysis reactor and/or, the hydrogenation unit in step e).

14. The process as claimed in claim 1 wherein no hydrogen is fed to the cracker in step d).

15. The process as claimed in any claim 1 wherein the coke forms on the catalyst used in step d) and that catalyst is regenerated by oxidizing this coke in a regenerator.

16. The process as claimed in claim 1 where the cracker is a fluid catalytic cracker or a steam cracker.

17. The process as claimed in claim 1 where the cracker is a fluid catalytic cracker and coke can be formed therein and removed to enhance to hydrogen to carbon ratio of the material remaining within the cracker.

18. System arranged to perform a process as defined in claim 1, wherein said apparatus comprises:
a) a pyrolysis reactor configured to receive a mixed plastic waste stream and to produce a pyoil;
b) a hydrotreatment unit configured to receive hydrogen and the pyoil and to produce a hydrotreated pyoil;
c) a separation unit configured to receive the hydrotreated pyoil and to produce three fractions: a light fraction, medium fraction and heavy fraction; and
d) a catalytic cracking reactor configured to receive the heavy fraction and to produce a cracked heavy fraction.

19. The system as claimed in claim 14, further comprising a recircualtion conduit directly connecting the catalytic cracking reactor to the pyrolysis reactor and/or the hydrotreatment unit.
